(19) United States
(12) Patent Application Publication
(10) Pub. No.: US 2016/0063512 A1
(43) Pub. Date: Mar. 3, 2016

(54) IDENTIFYING A CLOUD SERVICE USING NETWORK TRAFFIC AND OTHER DATA

(71) Applicant: CA, INC., ISLANDIA, NY (US)

(72) Inventors: Steven L. Greenspan, Scotch Plains, NJ (US); Olga Lagunova, Butler, PA (US); Peter Brian Matthews, Berkhamsted, Hertfordshire (GB); Serguei Mankovskii, Morgan Hill, CA (US); John J. Harrison, JR., Northborough, MA (US)

(21) Appl. No.: 14/471,010

(22) Filed: Aug. 28, 2014

(51) Int. Cl. G06Q 30/02; H04L 12/26

(52) U.S. Cl. CPC G06Q 30/0201; H04L 43/062

(57) ABSTRACT

Managing cloud service usage includes receiving an identity of a potential cloud service provider utilized by an entity of the enterprise, wherein the identity of the potential cloud service provider is based on network traffic information of the enterprise. Management also includes receiving additional information related to the potential cloud service provider, wherein the additional information is in addition to the network traffic information; and analyzing the identity of the potential cloud service provider and the additional information. Also, based on the analysis, a list of cloud service providers utilized by the enterprise is revised.

### RELATED APPLICATIONS

The present disclosure is related to a co-pending application entitled “IDENTIFYING A CLOUD SERVICE USING MACHINE LEARNING AND ONLINE DATA” (Attorney Docket No. US20140215US1), filed on the same date as the present application, the disclosure of which is incorporated herein, by reference, in its entirety.

### BACKGROUND

The present disclosure relates to computer resource tracking and, more specifically, to analyzing network traffic.

Cloud computing providers offer their services according to several fundamental models: infrastructure as a service (IaaS), platform as a service (PaaS), and software as a service (SaaS) where IaaS is the most basic and each higher model abstracts from the details of the lower models. In the most basic cloud-service model, providers of IaaS offer computers—physical or virtual machines—and other resources.

For example, a hypervisor can run various virtual machines as guests and pools of hypervisors within the cloud operational support-system can support large numbers of virtual machines and the ability to scale services up and down according to customers' varying requirements. IaaS clouds often offer additional resources such as a virtual-machine disk image library, raw block storage, and file or object storage, firewalls, load balancers, IP addresses, virtual local area networks (VLANs), and software bundles. IaaS-cloud providers supply these resources on-demand from their large pools installed in data centers.

To deploy their applications, cloud users install operating-system images and their application software on the cloud infrastructure. In this model, the cloud user patches and maintains the operating systems and the application software. Cloud providers typically bill services (e.g., IaaS, SaaS, etc.) on a utility computing basis wherein the cost reflects the amount of resources allocated and consumed.

As cloud service usage grows in many business and enterprises, these organizations may benefit from identifying how much and how often cloud services are being utilized by personnel within the organization.

### BRIEF SUMMARY

According to one aspect of the present disclosure, a method for managing cloud service usage includes receiving an identity of a potential cloud service provider utilized by an entity of the enterprise, wherein the identity of the potential cloud service provider is based on network traffic information of the enterprise. The method also includes receiving additional information related to the potential cloud service provider, wherein the additional information is in addition to the network traffic information; and analyzing the identity of the potential cloud service provider and the additional information. Also, based on the analysis, a list of cloud service providers utilized by the enterprise is revised.

According to another aspect of the present disclosure, a system for managing cloud service usage of an enterprise includes a memory storage device, and a processor configured to execute instructions stored in the memory storage device. The instructions when executed by the processor cause the system to receive an identity of a potential cloud service provider utilized by an entity of the enterprise, wherein the identity of the potential cloud service provider is based on network traffic information of the enterprise. The instructions when executed also cause the system to receive additional information related to the potential cloud service provider, wherein the additional information is in addition to the network traffic information; and analyze the identity of the potential cloud service provider and the additional information. The system can also revise a list of cloud service providers utilized by the enterprise, based on the analysis.

According to another aspect of the present disclosure, a computer program product for managing cloud service usage of an enterprise includes a non-transitory computer readable storage medium having computer readable program code embodied therewith. The computer readable program code includes computer readable program code for a) receiving an identity of a potential cloud service provider utilized by an entity of the enterprise, b) receiving additional information related to the potential cloud service provider, c) for performing analysis of the identity of the potential cloud service provider and the additional information, and d) revising, based on the analysis, a list of cloud service providers utilized by the enterprise, wherein the identity of the potential cloud service provider is based on network traffic information of the enterprise and the additional information is in addition to the network traffic information.

### BRIEF DESCRIPTION OF THE DRAWINGS

Aspects of the present disclosure are illustrated by way of example and are not limited by the accompanying figures with like references indicating like elements.

FIG. 1 illustrates an example computing environment in which a network analysis framework can be deployed in accordance with the principles of the present disclosure.

FIG. 2 illustrates a flowchart of an example network traffic classifier in accordance with the principles of the present disclosure.

FIG. 3A illustrates a flowchart of an example network traffic tracker in accordance with the principles of the present disclosure.

FIG. 3B illustrates a flowchart of an example method of determining cloud service providers in accordance with the principles of the present disclosure.

FIG. 3C illustrates a flowchart of another example method of determining cloud service provider in accordance with the principles of the present disclosure.

FIG. 4 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or by combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

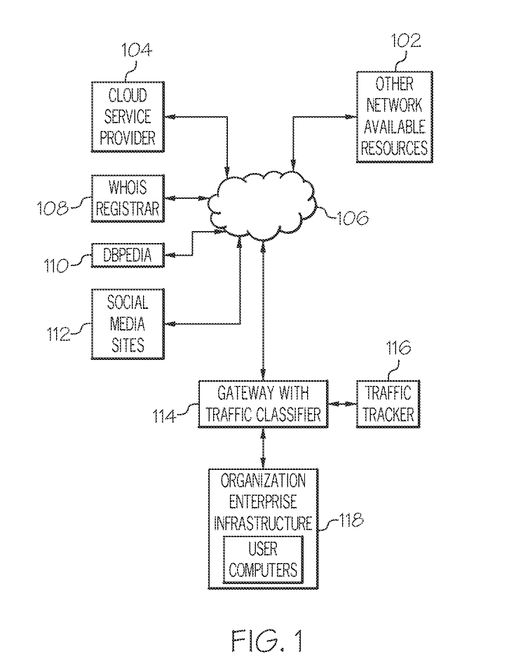

FIG. 1 illustrates an example computing environment in which a network analysis framework can be deployed in accordance with the principles of the present disclosure. An organization has an enterprise infrastructure 118 that includes a number of computing devices and users. These computing devices can include, for example, such resources as general purpose computers, tablets, devices, phones, laptops, printers, scanners, network-attached storage, and network infrastructure. A common capability of these computing devices is an ability to communicate through a network 106 with other computing resources. For example, other network-attached resources 102 may be available to communicate with the enterprise infrastructure 118.

One type of resource that can be communicated with through the network 106 is a cloud service provider 104. Such a provider 104 can provide IaaS, PaaS, and/or SaaS that can be utilized by one or more users or devices within the enterprise infrastructure 118.

In many organizations a gateway system or component may be located between the enterprise infrastructure 118 and the network 106 such that most, or all, network traffic to and from the infrastructure 118 passes through that gateway. One of ordinary skill will recognize that such a gateway can be a single component or a distributed plurality of systems that cooperatively perform the functions of the gateway.

In FIG. 1, in accordance with the principles of the present disclosure, the gateway 114 is depicted as including a component that performs network traffic classification. The network-traffic classifier/gateway 114 is located relative to the infrastructure 118 so that it can have access to network traffic to and from the infrastructure 118. As explained in more detail below, the network-traffic classifier 114 can analyze the network traffic to determine communications involving cloud services such as those involving the cloud service provider 104. Along with analyzing network traffic, the network-traffic classifier 114 can communicate analysis results to a traffic tracking component 116.

Additionally, a variety of information resources are available and accessible through the network 106. The resources 108, 110, 112 shown in FIG. 1 are provided merely by way of example and are meant to represent the wide variety of information that can be used in accordance with the principles of the present invention.

For example, a WHOIS registrar 108 can be queried to determine an association between an organization, one or more IP addresses, one or more uniform Resource Identifiers (URIs), and one or more domain names. Resources, similar to DBpedia 110, allow users to query relationships and properties associated with Wikipedia resources, including links to other related datasets. A wide variety of social media sites 112 also exist that can be automatically queried by a computer system to identify publicly-available information about organizations, web sites, enterprises and individuals.

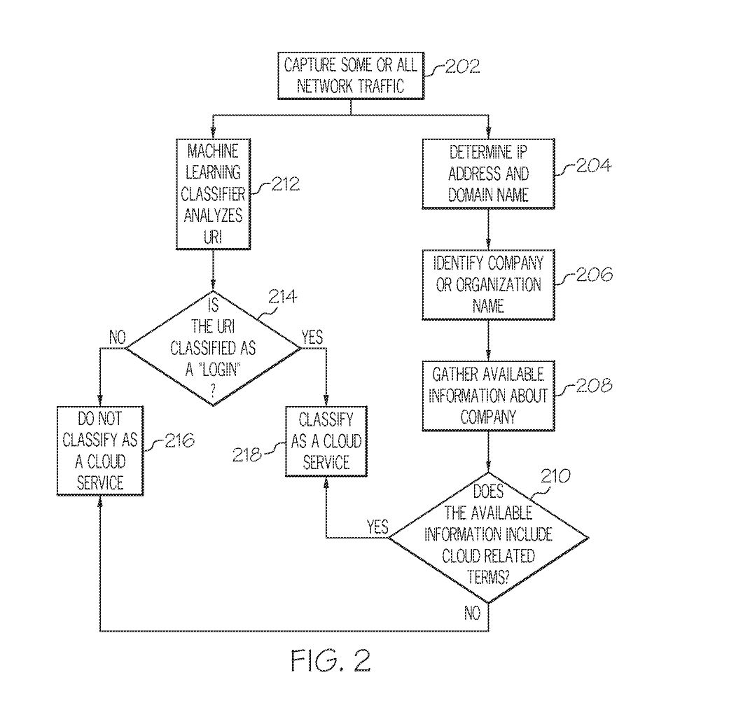

FIG. 2 illustrates a flowchart of an example network traffic classifier in accordance with the principles of the present disclosure. The various steps and functions depicted in FIG. 2 are performed automatically or autonomically by a programmed computer system without requiring human interaction and, therefore, can scale to large enterprises and organizations where network traffic patterns can change quickly and involve large amounts of data. Thus, in step 202 a network traffic analyzer/classifier can capture network traffic of the enterprise infrastructure as an initial step. The network traffic of particular interest to an organization can include traffic involving a network connection between a resource of the enterprise infrastructure 118 and an endpoint (e.g., 104) outside of the enterprise infrastructure 118.

Not all of the network traffic of the enterprise necessarily needs to be capture and analyzed. For example, various filters can be applied to the enterprise's network traffic to capture traffic only within a connection having an endpoint outside of the enterprise. Additionally, that subset of traffic can be further filtered based on various traffic attributes such as the communication protocol (e.g., whether or not it is encrypted). For example, traffic utilizing “https” instead of merely using “http” may be of more interest and thus the traffic captured in step 202 for further analysis can be limited to “https” traffic.

One goal of capturing network traffic in step 202 is to identify a URI or IP address of an endpoint outside the enterprise being communicated with over a network connection. As shown in FIG. 2, a URI can be passed to a machine learning classifier that analyzes, in step 212, the URI. The URI can also be used in step 204 to determine an IP address and/or domain name associated with that URI.

In step 206, the domain name and/or IP address can be used to discover information about the organization associated with that domain name. For example, the network classifier 114 can automatically query a WHOIS registrar (or other registrar) 108 to identify a “Registrant Name”, for example. Steps 202-206 can occur independently for a number of different network connection endpoints and, therefore, result in a number of different organization names being discovered in step 206. Those organization names represent a pool of potential cloud services with which enterprise computers are communicating.

The URI and the organization name for a particular endpoint can be used, in step 208, to query information resources on the Internet to identify additional information about the endpoint. In response to queries of one or more structure information sources or general search engines, a variety of documents and data will be returned that can be lexically analyzed for common words and concepts. For example, a SPARQL query against DBpedia using the organization name and URI will return an ontology from which keywords can be automatically extracted. In addition, social media sites such as LinkedIn and Facebook may also be queried for information about an endpoint.

Thus, in step 210, the information gathered in step 208 is analyzed to determine if words or phrases typically related to cloud services are present. For example, if the gathered information includes: “cloud”, “cloud provider”, “SaaS”, “software as a service”, “PaaS”, “IaaS”, etc., then the particular endpoint can be classified as a cloud service provider, in step 218. One of ordinary skill will recognize that various techniques for lexically analyzing datasets can be used which rely on a variety of factors such as the presence of keywords, the semantic context of keywords, the proximity of keywords near one another, the number of occurrences of keywords, etc.

Returning to step 212, the URI itself may provide evidence that an endpoint is a cloud service provider. A “machine learning” classifier can be used in step 212 to analyze the URI and classify the endpoint as either a cloud service provider or not.

One of ordinary skill will recognize, machine learning, a branch of artificial intelligence, involves systems that can learn from data. For example, in accordance with the principles of the present disclosure, a machine learning system could be trained on network traffic (e.g., packet contents, IP addresses, keywords, URIs, etc.) to learn to distinguish traffic involving an endpoint that is a cloud service and traffic that involves endpoints that are not cloud services. After learning, the system can then be used to classify new network traffic samples into one of the two type of traffic. A variety of different machine learning techniques and algorithms can be used without departing from the scope of the present disclosure.

As an example, the classifier can be trained on a variety of endpoint URIs that include both non-cloud related services and cloud related services. For example, “https://login.salesforce.com” and “https://www.dropbox.com/login” are examples of cloud related services and both include “login” with the URI. Similar phrases like “signin” or the like will add additional weight that a URI is related to a cloud service and step 214 determines if the URI is a “login” URI. Based on the determination in step 214, the URI (i.e., the endpoint) is classified as either a cloud service (step 218) or not a cloud service (step 216). Those endpoints classified as a cloud service provider have an associated indicator stored by the traffic classifier that indicates that the endpoint is a cloud service provider.

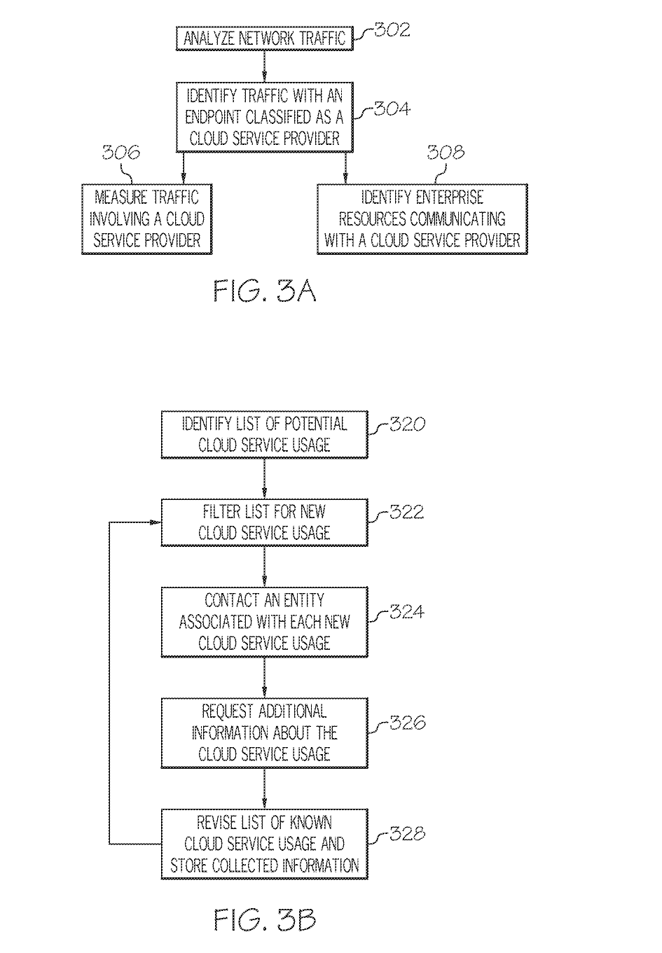

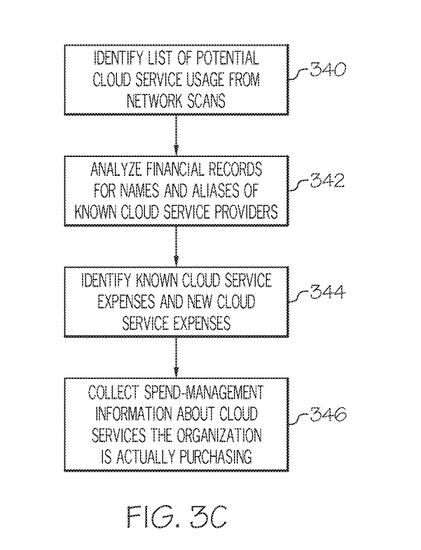

FIG. 3A illustrates a flowchart of an example network traffic tracker in accordance with the principles of the present disclosure. Once an endpoint is classified as a cloud service provider, then network traffic involving that endpoint can be tracked. For example, the source IP address (within the enterprise) of traffic involving the cloud service endpoint can be compared to an enterprise's asset management database to determine an owner of the enterprise resource accessing the cloud service. Thus, information about the number and the roles of the enterprise users interacting with a cloud service can be determined.

Thus, the operation of the traffic classifier 114 described in relation to FIG. 2 can have additional functionality associated with a traffic tracker 116. The network classifier can, in step 302, analyze traffic and identify, in step 304, if an indicator exists that the endpoint has already been classified as a cloud service provider. If not, then the classifier can examine the endpoint as described above with respect to FIG. 2. However, if the endpoint has already been classified as a cloud service provider, then its URI and/or IP address need not be further analyzed for classification purposes. Instead, the traffic involving this endpoint can be further analyzed for additional information. For example, in step 306, an amount of traffic involving the cloud service provider can be measured and tracked. Such information may allow an enterprise to determine characteristics about how its computing resources are being used. In step 308, the traffic involving this endpoint can be analyzed to determine which particular resources within an enterprise are communicating with the cloud service provider.

The above description relates to one example way to discover usage of cloud services. However, cloud service identification generally refers to any process for identifying what cloud services are used by an organization or enterprise and can also include additional information such as, for example, whether or not the cloud service is free can be collected. An organization or enterprise can include a team or other group of personnel that focus on identifying and tracking cloud service usage but, in some instances, such goals can be difficult to accomplish because cloud services are often ephemeral and virtualized.

Cloud services, for example, can be selected and used by business units of an organization in a way that bypasses the internal Information Technology (IT) staff of that organization. Accordingly, “shadow-IT” can exist that is outside the knowledge and control of the IT staff. Many organizations find it beneficial to identify and/or monitor such shadow-IT.

Identification of cloud services can be accomplished by scanning network event streams, system logs and various network client records for signatures of cloud services. Some example techniques can include looking for applications such as DropBox being installed, searching in a browser's history file, plugins or cookies, and scanning and analyzing network streams as described above. The typical outcome will be generation of a list of potential cloud services. Once generated, this list of potential cloud services can be compared to an organization's records to identify possible policy violations or previously undiscovered cloud service usage.

The list of potential cloud services, however, may be over inclusive and include false positives while also being under-inclusive and missing some potential cloud services being used. For example, personnel of the organization may download software but not subsequently use it, may purchase other products from a company that also provides cloud services, may use a cloud service from a vendor that is not recognized as a cloud service provides, or enable private browsing that obscures automatic detection of cloud service usage. Thus, further analysis of the list of potential cloud services can be beneficial in revising that list. The term “revising” can encompass adding a new cloud service provider to the list, removing a potential cloud service provider from the list, and actively confirming that a potential cloud service provider should remain on the list.

Referring to FIG. 3B, an enterprise can, in step 320, identify a list of potential cloud service usage via analysis that, at least in part, includes analyzing network traffic information. In addition to network traffic information, or as an alternative, inspection of files and applications installed on a machine can also reveal potential cloud service usage. For example, the flowchart of FIG. 2 illustrates one example method of generating such a list that involves network traffic analysis. Next, in step 322, the enterprise can identify new cloud service usage information within that list.

For example, a previous version of the list can include all of the potential cloud service providers and/or cloud service usage that are either a) thought to involve cloud service usage of members of the enterprise or b) confirmed to be cloud service usage by members of the enterprise. When a new version of the list is generated in step 320, a comparison between the previous version and the new version of the list will reveal any new potential cloud service providers, or new potential cloud service usage, that may then be confirmed. Even though an enterprise may know of a cloud service provider already being used by members of the enterprise, the enterprise may also want to identify when additional, or new, usage of that particular cloud service provider occurs within the enterprise.

An enterprise will have available information that can identify end users, user devices, user accounts, organizational departments and other enterprise entity that is associated with particular network activity that may be detected. Thus, activity which caused a potential cloud service usage event to be added to the list 320 can be associated with a particular enterprise entity related to that event. As one simple example, network traffic may reveal an IP address associated with a potential cloud service usage and the enterprise can determine the department or person within the enterprise responsible for that IP address. More complex traffic analysis can investigate which user was currently logged into a machine when that machine was involved in adding an entry to the list in step 320. One of ordinary skill will recognize that there are a number of ways to determine an entity within an enterprise associated with an entry in the list of potential cloud service usage, without departing from the scope of the present disclosure. In step 324, the enterprise can then contact the identified entity about the potential new cloud service usage and, in step 326, request additional information about the potential cloud service usage. Contact of the entity can occur, for example, via email, via telephone, via instant messaging, via paper-based reporting, via a web survey application, etc.

The additional information requested from the entity can include, for example: confirmation that cloud service usage is occurring, identification of any other cloud services being used, identification of any sub accounts for these services, permission for the enterprise to access usage data of the cloud service (and information necessary to perform such access), identification of costs or financial records associated with the cloud service usage, identification of business reasons for the cloud service usage. As one of ordinary skill will readily recognize, the requesting of additional information in step 326 and its collection can be performed automatically or semi-automatically using one or more computer-based platforms within the enterprise. Particularly, electronic messages such as email responses or user-filled forms from a web survey can be autonomically analyzed so that information pertinent to cloud service usage can be extracted and utilized by the enterprise.

Thus, the additional information collected in step 326 can be used by the enterprise, in step 328, to revise the list of known cloud service usage. Thus, the list of known, or confirmed, cloud service usage can be extended or pruned based on the additional information. As one specific example, network traffic information may initially be useful to identify a new potential cloud service provider and the additional information from the entity within the enterprise can be useful in confirming service usage of that provider. Thus, both the network traffic information and the information in addition to the network traffic information can be used to determine that a new cloud service provider should be added to a list of cloud service providers providing services to members of the enterprise.

As an alternative to directly inquiring of entities of the enterprise whether or not they are utilizing cloud services, financial records of the enterprise can also be analyzed to augment information collected about potential cloud service usage from within the enterprise. Referring to FIG. 3C, an enterprise, in step 340, may initially identify a list of potential cloud service usage from network traffic information, similar to the techniques and methods already described.

In addition, however, the enterprise can, in step 342, also analyze financial records for names or aliases of known cloud service providers. The financial records can include both paper and electronic versions of general ledgers, invoice system data, and/or credit card reports, for example. The enterprise can then correlate the information from the financial records with a priori network traffic and device inspection data (e.g., compiled in the list generated in step 340). In this way, the enterprise can discover which cloud services are being used and being expensed.

Thus, in step 344, the financial records are a second source of data that can identify cloud service usage that was not discovered through network traffic scans and can validate, or confirm, any identification of potential cloud service usage that was discovered through network scans. Correlating the two methods of collecting information can identify services that the other method missed and raise questions about services identified by one method and not the other. In addition, or as an alternative, if the enterprise is primarily focused on spend-management, then, in step 346, the inspection of financial records, as opposed to merely network traffic analysis, helps determine cloud services the enterprise is actually purchasing.

The term “entity” can potentially encompass various people, accounts, devices or organizational units within an enterprise. Typically, an entity can be an individual, such as an employee or contractor, of the enterprise. An entity of an enterprise can also refer to an account (e.g., identified by login credentials) that is associated with a particular individual within the enterprise or an entity can refer to a particular device that is associated with an individual or organizational unit of the enterprise. In a broader sense, an entity can also refer to an organizational unit (e.g., department, building location, etc.) of an enterprise. For example, when a query for additional information is made to an entity that is believed to have utilized a cloud service, it may be sufficient in some instances to resolve the entity's identity to the “Finance Department” rather than specifically to “John Smith in the Finance Department”. In other instances it may be beneficial to resolve the entity's identity to a particular individual of the enterprise or a specific device used by an individual of the enterprise.

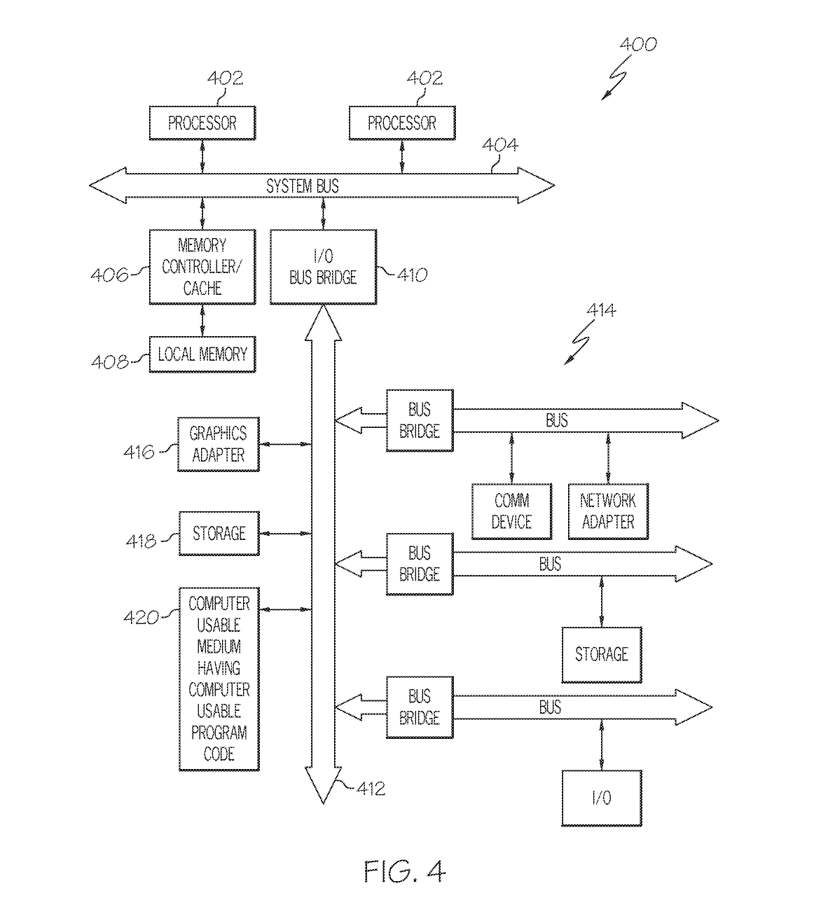

Referring to FIG. 4, a block diagram of a data processing system is depicted in accordance with the present disclosure. A data processing system 400, such as may be utilized to implement the hardware platform 102 or aspects thereof, e.g., as set out in greater detail in FIG. 1-FIG. 3C, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more buses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 3.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method for managing cloud service usage, comprising:
receiving, by a computer related to an enterprise, an identity of a potential cloud service provider utilized by an entity of the enterprise,
wherein the identity of the potential cloud service provider is based on network traffic information of the enterprise;
receiving, by the computer related to the enterprise, additional information related to the potential cloud service provider,
wherein the additional information is in addition to the network traffic information;
analyzing, by the computer related to the enterprise, the identity of the potential cloud service provider and the additional information; and
based on the analyzing, revising, by the computer related to the enterprise, a list of cloud service providers utilized by the enterprise.

2. The method of claim 1, wherein revising the list of cloud service providers comprises adding the identity of the potential cloud service provider to the list.

3. The method of claim 1, wherein revising the list of cloud service providers comprises removing the identity of the potential cloud service provider from the list.

4. The method of claim, 1, comprising:
before revising the list, determining whether or not the list includes the identity of the potential cloud service provider.

5. The method of claim 1, comprising:
identifying, by the computer related to the enterprise, the entity of the enterprise;
sending, by the computer related to the enterprise, a query for more information about the potential cloud service provider to the entity of the enterprise; and
receiving, by the computer related to the enterprise, a response to the query,
wherein the response comprises the additional information.

6. The method of claim 5, wherein the query comprises data related to cloud service providers other than the potential cloud service provider.

7. The method of claim 5, wherein the query comprises data related to cloud service usage of the cloud service provider by the entity.

8. The method of claim 1, wherein the additional information comprises financial records of the enterprise.

9. The method of claim 8, wherein the financial records comprise an indication of spending by the enterprise.

10. The method of claim 9, comprising:
based on the list of cloud service providers and the additional information, generating, by the computer related to the enterprise, a report of cloud services purchased by the enterprise.

11. A system for managing cloud service usage of an enterprise, comprising:
a memory storage device;
a processor configured to execute instructions stored in the memory storage device, the instructions when executed by the processor cause the system to:
receive an identity of a potential cloud service provider utilized by an entity of the enterprise,
wherein the identity of the potential cloud service provider is based on network traffic information of the enterprise;
receive additional information related to the potential cloud service provider,
wherein the additional information is in addition to the network traffic information;
perform analysis of the identity of the potential cloud service provider and the additional information; and
revise a list of cloud service providers utilized by the enterprise, based on the analysis.

12. The system of claim 11, wherein revision of the list of cloud service providers comprises adding the identity of the potential cloud service provider to the list.

13. The system of claim 11, wherein revision of the list of cloud service providers comprises removing the identity of the potential cloud service provider from the list.

14. The system of claim 11, wherein the instructions, when executed by the processor, cause the system to:
determine, before revision of the list, whether or not the list includes the identity of the potential cloud service provider.

15. The system of claim 14, wherein the instructions, when executed by the processor, cause the system to:
identify the entity of the enterprise;
send a query for more information about the potential cloud service provider to the entity of the enterprise; and
receive a response to the query,
wherein the response comprises the additional information.

16. The system of claim 15, wherein the query comprises data related to cloud service providers other than the potential cloud service provider.

17. The system of claim 15, wherein the query comprises data related to cloud service usage of the cloud service provider by the entity.

18. The system of claim 11, wherein the additional information comprises financial records of the enterprise.

19. The system of claim 18, wherein the financial records comprise an indication of spending by the enterprise.

20. The system of claim 19, wherein the instructions, when executed by the processor, cause the system to:
generate, based on the list of cloud service providers and the additional information, a report of cloud services purchased by the enterprise.

21. A computer program product for managing cloud service usage of an enterprise, comprising:
a non-transitory computer readable storage medium having computer readable program code embodied therewith, the computer readable program code comprising:
computer readable program code for receiving an identity of a potential cloud service provider utilized by an entity of the enterprise,
wherein the identity of the potential cloud service provider is based on network traffic information of the enterprise;
computer readable program code for receiving additional information related to the potential cloud service provider,
wherein the additional information is in addition to the network traffic information;
computer readable program code for performing analysis of the identity of the potential cloud service provider and the additional information; and
computer readable program code for, revising, based on the analysis, a list of cloud service providers utilized by the enterprise.
